(19) United States
(12) Patent Application Publication
(10) Pub. No.: US 2007/0005927 A1
(43) Pub. Date: Jan. 4, 2007

(54) Systems and methods for remote triggering of page faults

(76) Inventors: Hormuzd M. Khosravi, Portland, OR (US); Uday Savagaonkar, Hillsboro, OR (US); Ravi Sahita, Beaverton, OR (US); Priya Rajagopal, Worcester, MA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/173,142

(22) Filed: Jun. 30, 2005

(51) Int. Cl. G06F 12/00

(52) U.S. Cl. 711/173; 711/203

(57) ABSTRACT

Systems and methods are described herein to provide for remote triggering of page faults.

### TECHNICAL FIELD

Various embodiments described herein relate generally to computer systems and more particularly to remote triggering of page faults.

### BACKGROUND

A conventional computing platform may include diagnostic hardware tools. An operator may employ these tools to maintain, monitor and/or troubleshoot the computing platform. Such tools are typically executed within the operating system environment of the platform. Accordingly, the usefulness of these tools is limited if the operating system environment crashes or is otherwise unavailable. Next-generation platforms may include an execution environment that is isolated from host operating system processes.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A is a high-level block diagram of a system according an example embodiment.

FIG. 1B is a more detailed block diagram of a system according to an example embodiment.

FIG. 2 is a flowchart of a method according to an example embodiment.

FIG. 3 is a flowchart of a method according to an alternate embodiment.

FIG. 4 is a more detailed block diagram of a system according an example embodiment.

FIG. 5 is a more detailed flowchart of a method according to an example embodiment.

FIG. 6 is a block diagram of system according to another embodiment.

### DETAILED DESCRIPTION

The following is a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which show by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter.

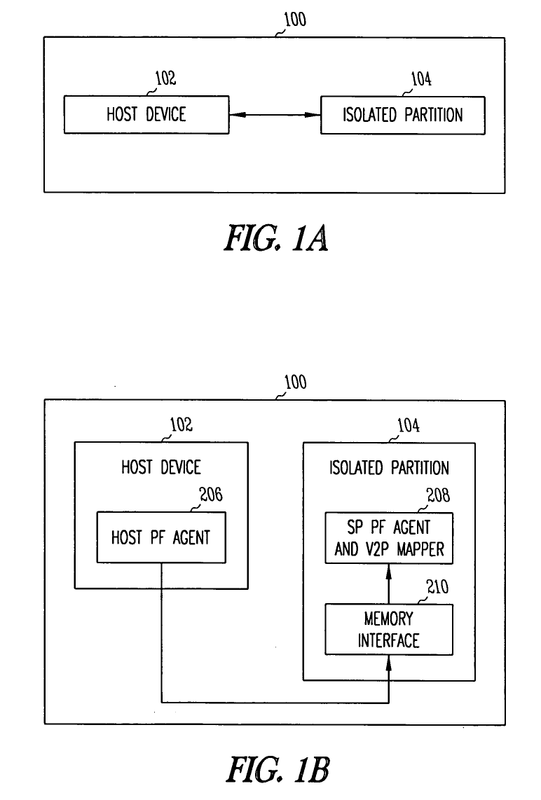

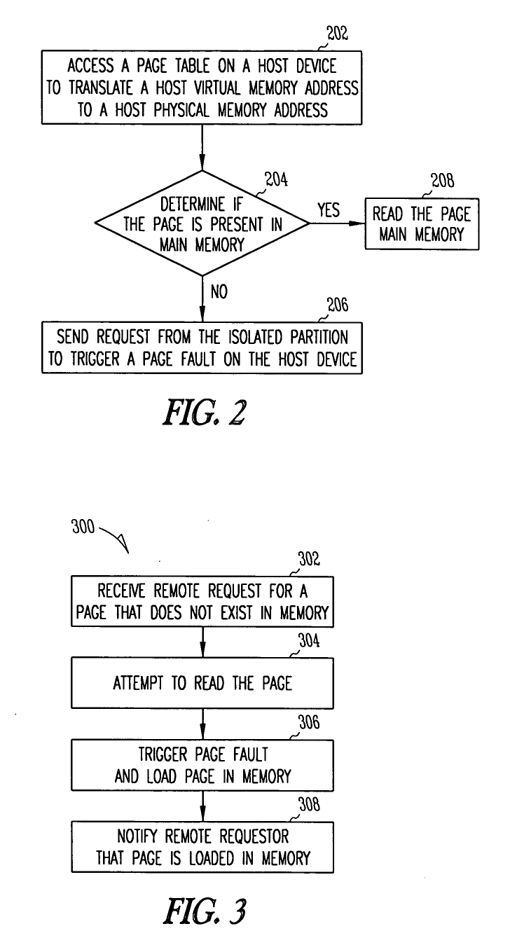

FIG. 1A is a high-level block diagram of a system according to an example embodiment. System 100 includes a host device 102 and an isolated partition 104. The isolated partition 104 is communicatively coupled to the host device 102 through any suitable means. In one embodiment, the host device 102 and the isolated partition 104 are communicatively coupled through a communications bus. The communications bus may represent one or more busses, e.g., USB (Universal Serial Bus), FireWire, PCI, ISA (Industry Standard Architecture), X-Bus, EISA (Extended Industry Standard Architecture), or any other appropriate bus and/or bridge (also called a bus controller).

The host device 102 is configured to perform operations implementing an operating system and other software applications. Operating systems may include operating systems based on Windows®, Unix, Linux, Macintosh®, and operating systems embedded on a processor. The host device 102 may include, without limitation, desktop PC, server PC, PDA, etc. The host device 102 is further configured to run one or more software applications. The software applications include, without limitation, stand alone software applications (i.e. word processing applications, login applications, and the like) and software applications that control hardware devices. Hardware devices include, without limitation, network interface cards, bus controllers, memory controllers, graphics cards, storage controllers and the like. In one embodiment, the host device 102 is configured to permit page faults to be remotely triggered on the host device from the isolated partition.

The isolated partition 104 is configured to perform remote triggering of page faults on the host device 102. In some embodiments, the isolated partition 104 is also configured to perform reconstitution of virtual memory. Reconstitution of virtual memory is the ability to translate the virtual and logical memory addresses on the host device 102 to physical memory addresses on the host device 102. The remote triggering of page faults and the virtual memory reconstitution methods are independent of the operating system running on the host device.

The isolated partition 104 is an isolated execution environment that is securely separated from the host device 102. The isolated partition 104 may be, but is not limited to, a service processor, a virtual partition, an embedded microcontroller, and the like. In one embodiment, the “isolated execution environment” is an execution environment that is configured to execute code independently and securely isolated from a host that it is communicatively coupled to. In a further embodiment, the isolated execution environment is further configured to prevent software running on the host from performing operations that would alter, modify, read, or otherwise affect the code store or executable code that is running in the isolated execution environment.

In an embodiment, the isolated partition 104 is configured to trigger a page fault on a host device 102 when a page is unavailable in memory. In such an arrangement, the host device 102 is configured to send to the isolated partition 104 a notification when a page becomes available in memory after a page fault is trigger on the host device 102.

FIG. 1B is a more detailed block diagram of a system according to an example embodiment. The system 100 includes a host device 102 and an isolated partition 104 communicatively coupled. The host device 102 includes a Host Page Fault Agent (“Host PF Agent”) 206. The isolated partition 104 includes a Service Processor Page Fault Agent (“SP PF Agent”) 208. The isolated partition also optionally includes a Virtual to Physical Mapper (“V2P Mapper”) 208 and a memory interface 210.

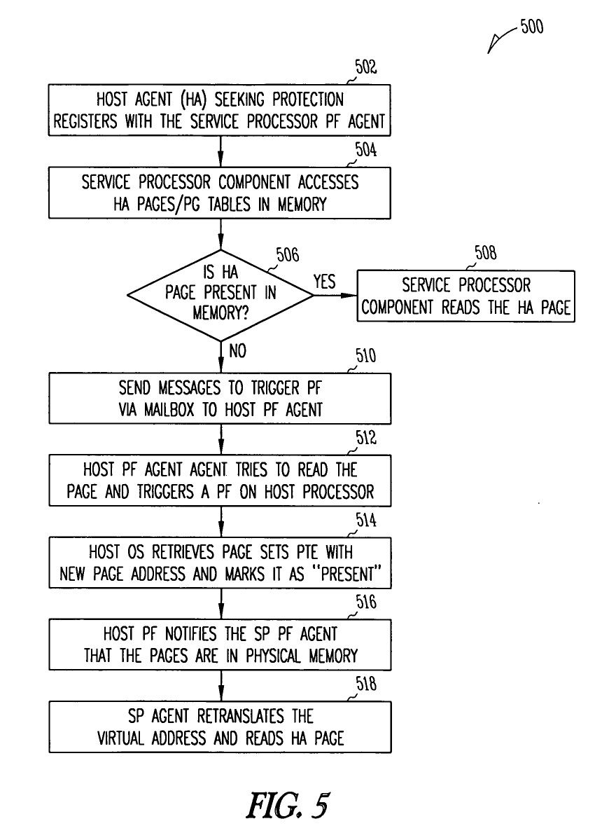

The Host PF Agent 206 of the host device 102 is configured to notify the isolated partition 104 when a page is loaded in physical memory in response to page fault trigger from the isolated partition 104. The Host PF Agent 206 may be software or firmware. In another embodiment, the Host PF Agent 206 may be a combination of hardware devices and software resources. Host PF Agent 206 is discussed in greater detail below with respect to FIG. 4.

The memory interface 210 is configured to pass data between the host device 206 and the isolated partition 208. In one embodiment, the memory interface 210 uses Direct Memory Access (DMA) to access the host device memory.

The SP PF Agent 208 of the isolated partition 104 is configured to remotely trigger page faults on the host device from the isolated partition 104. Isolated partition 104 can thus access and manage non-pinned memory pages. The SP PF Agent 208 may be software or firmware. In another embodiment, the SP PF Agent 208 may be a combination of hardware devices and software resources. SP PF Agent 208 is discussed in greater detail below with respect to FIG. 4.

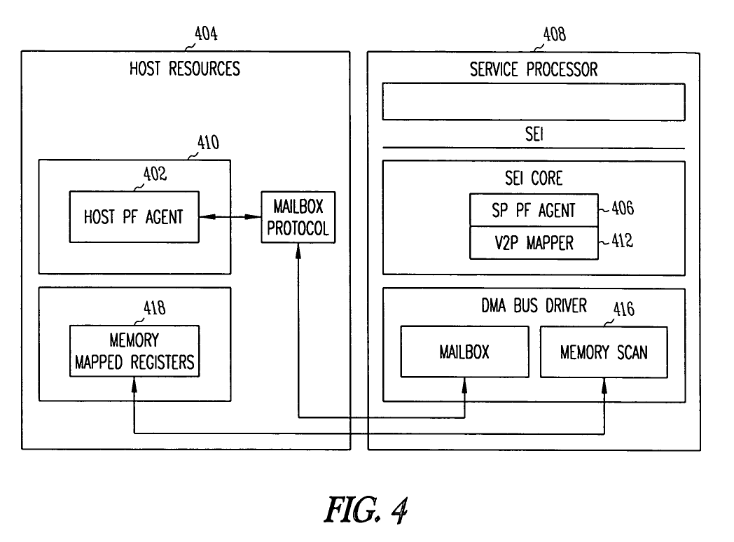

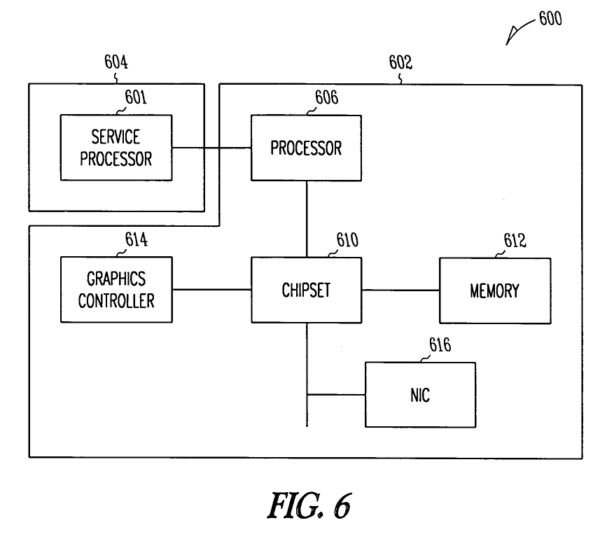

FIG. 2 is a flowchart of a method 200 according to an example embodiment. In an embodiment, the operations in FIG. 2 are carried out in an isolated partition 104. As discussed above, the isolated partition 104 is configured to remotely trigger a page fault on a host device. At block 202, a page table is accessed on the host device to translate a host virtual memory address to a host physical memory address. At block 204, it is determined if the page exists in memory. At block 206, when the request is not present in memory, a request is sent from the isolated partition to trigger a page fault on the host device. At block 208, the memory is read by the isolated partition if the page exists in memory. Methods performed by the SP PF Agent are described in greater detail below with respect to FIG. 5.

In an embodiment, the operations depicted in FIG. 2 are performed on behalf of a third party device on the isolated partition 104. The third party device requires the contents of memory to perform management functions. Management functions include, without limitation, management controller activities and host software agent measurement. In another embodiment, the third party device includes a capability module. In such an arrangement the capability module is configured to perform management activities. In one embodiment, the capability module requests supported event types from a management core on the isolated partition 104. In such an arrangement, during host device start-up or the hot-swapping of a hardware component coupled to the host device 102, the management core queries one or more host device drivers on the host device 102 for event types supported by the host device driver. The management core receives a response to the query and caches the event types supported by the host device drivers on the host device 102. The management core receives the request for event types from the capability module and determines which of the event types cached match the request. The capability modules registered to the event type can then subscribe to that event type and perform management activities using event data related to that event type. In the context of the present discussion, the capability module requires the contents of a virtual memory address to perform one or more of those management activities. The management core, using the V2P mapper, receives the request from the capability module, translates the virtual memory address in the request to a physical memory address and then if the page is not present in physical memory, triggers a page fault to move the page into physical memory. Once the page is present in physical memory the management core retrieves the contents of the physical memory address and returns that to the capability module.

FIG. 3 is a flowchart of a method according to an alternate embodiment. In an embodiment, the operations depicted in FIG. 3 show operations carried out on a host device 102. At block 302, a remote request is received for a page that does not exist in memory. At block 304, the host processor attempts to read the page, but instead triggers a page fault. At block 306, a page fault is triggered and the page is loaded in memory. At block 308, the remote requester is notified that the page is present in memory. Optionally, and not shown in FIG. 3, the method may also comprise locking the page in main memory so that it can not be swapped out to disk before the remote requester can access it.

FIG. 4 is a more detailed block diagram of a system according to an example embodiment. FIG. 4 illustrates one example of components of a page fault system 400. System 400 comprises a Host Page Fault (PF) agent 402 running on a host processor 404 and a Service Processor Page Fault (SP PF) agent 406 running on an adjunct or service processor 408. In one example, Host PF agent 402 is located with the Host Device Drivers 410. Also as an example, the SP PF agent 406 is part of a V2P Mapper 412 running on the service processor.

When service processor 408 would like to access a page in physical memory, V2P Mapper 412 must first determine if the page is present in physical memory. Through a DMA bus driver 414, V2P Mapper 412 directs an associated memory scan device 416 to access the memory mapped registers 418. The information from the memory mapped registers 418 is used to determine if the desired page is present in physical memory. If the page is not present in physical memory, a page fault must be triggered to move the desired page into physical memory.

Once a page fault is desired by V2P Mapper 412, SP PF agent 406 sends a trigger message to Host PF agent 402. Host PF agent 402 receives the trigger message and causes a page fault on the host processor 404. In one example, after the desired page(s) have been loaded into physical memory, Host PF agent 402 sends a return message to SP PF agent 406 notifying SP PF agent that the page is present in physical memory. The associated memory scan device 416 can then access the page in physical memory.

FIG. 5 illustrates one example of a page fault method 500. Method 500 begins by a Host Agent (HA) registering with a Service Processor Page Fault (SP PF) Agent at block 502. In one example, Host Agent provides information to SP PF agent such as the starting virtual address of Host Agent and the size of Host Agent in memory. Host Agent may additionally provide information needed to access HA Page Tables such as the control register 3 (CR3) value of Host Agent. Once SP PF has acquired information it may then provide any information to an associated service processor component as needed.

The method 500 continues at block 504 by Service processor component accessing the HA Page Tables to translate a HA page virtual address. Service processor component is attempting to access a HA page and must first translate the HA page virtual address to locate the HA page in physical memory. Service processor component acquires HA information from the SP PF agent. The HA information is then used by Service processor component to access HA Page Tables.

In one embodiment, the service processor component includes a capability module on the isolated partition 104, the capability module to receive and process event management data and to perform management activities based on that data.

Continuing at block 506, Service processor component determines if a Host Agent page that service processor component would like to access is present in physical memory. Service processor component looks through HA Page Tables to check if HA page is marked as “present” in physical memory. HA page is present in memory if the present flag in the Page Table Entry (PTE) of HA page is set to a logical ‘1’.

If HA page is present in memory, then at block 508 service processor component reads HA page from memory.

If HA page is not present in physical memory, then at block 510 service processor component triggers a Page Fault on HA page. In one example, service processor component instructs SP PF agent to send a trigger message to Host Page Fault Agent. SP PF agent then sends trigger message through a communication channel to the Host Page Fault Agent. Trigger message instructs the Host Page Fault Agent to read Host Agent page.

Once Host Page Fault Agent receives trigger message from SP PF agent at block 510, Host Page Fault Agent tries to read HA page from physical memory at block 512. Since HA page is not present in physical memory a Page Fault is triggered on a host processor.

The method 500 continues at block 514 by a Host OS retrieving HA page and placing HA page in memory. The Page Fault on host processor causes Host OS to locate HA page and load HA page into physical memory. Host OS also sets Page Table Entry present flag to a logical ‘1’. Additionally Host OS will update the PTE with the new HA page address.

Once Host OS has completed processing the Page Fault at block 514, Host PF agent notifies SP PF agent that the HA page is in physical memory at block 516.

After SP PF agent receives notification from Host PF agent, service processor component accesses HA page at block 518. Service processor component receives notification from SP PF agent that HA page has been loaded into physical memory. Service processor component then accesses HA page by retranslating the virtual address of HA page. The virtual address is retranslated by accessing HA page tables and reading the PTE of the HA page. Once the HA page has been located in physical memory it is read by service processor component.

FIG. 6 is a block diagram of system according to another embodiment. System 600 includes an isolated partition 604 and host device 602. Isolated partition 604 includes a service processor 608 which may remotely trigger page faults on a host device. Host device 602 comprises processor 606. Host device 602 also includes chipset 610 and memory 612. Memory 612 may comprise any suitable type of memory, including but not limited to Single Data Rate Random Access Memory and Double Data Rate Random Access Memory. Other functional units of host device 602 include graphics controller 614 and Network Interface Controller (NIC) 616, each of which may communicate with processor 606 via chipset 610.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments and other embodiments not specifically described herein will be apparent to those of skill in the art upon reviewing the above description.

The Abstract of the Disclosure is provided to comply with 37 C.F.R. § 1.72(b), requiring an abstract that allows the reader to quickly ascertain the nature of the technical disclosure. It is submitted with the understanding that it will not be used to interpret or limit the scope or meaning of the claims. Additionally, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the terms “comprising” and “wherein,” respectively. Moreover, the terms “first,” “second,” and “third,” etc. are used merely as labels, and are not intended to impose numerical requirements on their objects.

What is claimed is:

1. A method comprising:
accessing, from an isolated partition, a page table on a host device to translate a host virtual memory address to a host physical memory address;
determining if the host physical memory address is present in memory; and
when the physical memory address fails to be present in memory, sending a request, from the isolated partition, to trigger a page fault on the host device.

2. The method of claim 1 further comprising receiving notification from the host processor when the page is loaded in memory in response to the page fault.

3. The method of claim 1 further comprising retrieving data from the host device memory after the page to loaded in memory in response to the page fault.

4. A machine-accessible medium having machine executable instructions contained therein, which when executed perform operations comprising:
triggering, from an isolated partition, a page fault on a host device when a page is unavailable;
sending, from a host device, to the isolated partition, a notification when the page becomes available in memory.

5. The medium of claim 6 further comprising loading the page in memory on the host processor in response to the page fault.

6. The medium of claim 7 further comprising accessing the page from the isolated partition.

7. An apparatus comprising:
a memory to store executable program code;
a memory management unit; and
a processor to operate in conjunction with the executable program code to:
retrieve, from the memory management unit on a host, data to translate a virtual memory address to a physical memory address;
pass the data to a service processor; and
receive a request from the service processor for a page fault.

8. The apparatus of claim 7 further comprising attempting to read the page and triggering a page fault.

9. The apparatus of claim 7 further comprising loading the page and notifying the service that the page is loaded.

10. The apparatus of claim 11 further comprising locking the page in memory so that it can not be swapped out before the service processor can access it.

11. A system comprising:
an isolated partition, the isolated partition having a module to reconstitute virtual memory and to remotely trigger a page fault;
a host device including:
memory to store executable program code;
a memory management unit; and
a processor to operate in conjunction with the executable program code to:
retrieve, from the memory management unit on a host, data to translate a virtual memory address to a physical memory address;
pass the data to an agent on the isolated partition; and
receive a request from the an agent on the isolated partition for a page fault.

12. The apparatus of claim 11 further comprising attempting to read the page and triggering a page fault.

13. The apparatus of claim 12 further comprising loading the page and notifying the service that the page is loaded.

14. The apparatus of claim 13 further comprising locking the page in memory so that it can not be swapped out before the agent can access it.

15. The apparatus of claim 11 wherein the executable program code runs in a system management mode of the processor.

16. The apparatus of claim 11 wherein executable program code runs as a kernel agent on the processor.
